(19) United States
(12) Patent Application Publication
(10) Pub. No.: US 2015/0171451 A1
(43) Pub. Date: Jun. 18, 2015

(54) FUEL CELL

(71) Applicants: Kenji Tsubosaka, Susono-shi (JP); Hiroo Yoshikawa, Susono-shi (JP); Kenji Sato, Susono-shi (JP); Kensuke Shiina, Tokyo-to (JP)

(72) Inventors: Kenji Tsubosaka, Susono-shi (JP); Hiroo Yoshikawa, Susono-shi (JP); Kenji Sato, Susono-shi (JP); Kensuke Shiina, Tokyo-to (JP)

(73) Assignee: TOYOTA JIDOSHA KABUSHIKI KAISHA, Toyota-shi (JP)

(21) Appl. No.: 14/635,716

(22) Filed: Mar. 2, 2015

Related U.S. Application Data
(62) Division of application No. 11/902,219, filed on Sep. 20, 2007.

(30) Foreign Application Priority Data
Sep. 20, 2006 (JP) 2006-253999

(51) Int. Cl. H01M 8/10

(52) U.S. Cl. CPC H01M 8/1002; H01M 2008/1095; H01M 2300/0082

(57) ABSTRACT

A fuel cell includes: a membrane electrode assembly provided with an electrolyte membrane and gas diffusion electrodes attached to both sides of the electrolyte membrane; separators supporting the membrane electrode assembly from both sides thereof; a gas flow path forming member disposed between the separator and the gas diffusion electrode to form gas flow path for supplying reactant gas for power generation in the fuel cell to the gas diffusion electrode; and an elastic member disposed between the separator and the gas flow path forming member and having an elastic modulus which is lower than that of the gas flow path forming member.

### INCORPORATION BY REFERENCE

This is a divisional of U.S. application Ser. No. 11/902,219, filed on Sep. 20, 2007, which claims priority to Japanese Patent Application No. 2006-253999, filed on Sep. 20, 2006. Both of these applications are incorporated herein by reference in their entirety.

### BACKGROUND OF THE INVENTION

1. Field of Invention

The present invention relates to a fuel cell.

2. Description of Related Art

Fuel cells, which generate electricity through an electrochemical reaction between hydrogen and oxygen, are attracting attention as energy sources. A fuel cell is formed by interposing a membrane electrode assembly having a prescribed electrolyte membrane with proton conductivity and gas diffusion electrodes attached to both sides of the electrolyte membrane between separators.

In such a fuel cell, gas flow paths for supplying reactant gases, that is, hydrogen and oxygen, to the gas diffusion electrodes, respectively, are formed. The gas flow paths are formed as grooves in the separators or interposing members (gas flow path forming members) of a metal porous material, or the like, having electrical conductivity and gas diffusibility between the separators and the gas diffusion electrodes.

Various arts relating to such gas flow paths have been proposed (for example, see Published Japanese Translation of PCT application No. 2005-512278 (JP-T-2005-512278), Japanese Patent Application Publication No. 2006-85981 (JP-A-2006-85981)). For example, Published Japanese Translation of PCT application No. 2005-512278 (JP-T-2005-512278) describes an art in which gas flow paths are formed by a sandwich structure of a compressible and elastic metal mesh. Japanese Patent Application Publication No. 2006-85981 (JP-A-2006-85981) describes an art in which an elastic support body having electrical conductivity and elastically deformable are disposed between a separator and a flat plate-shaped unit cell (which corresponds to the above membrane electrode assembly) to form gas flow paths.

However, in a fuel cell formed by interposing a membrane electrode assembly between separators as described above, pressure is applied from both sides of the separators to prevent deterioration of cell performance due to an increase in contact resistance in any part of the fuel cell and to prevent gas leakage. Therefore, in the arts described in the above gazettes, an elastic member (“a sandwich structure of a compressible and elastic metal mesh” or “elastic support body”) is used to form gas flow paths, a failure may occur in which the shape of the gas flow paths is compressively deformed by the pressure until the cross-sectional areas of the flow paths are reduced and, consequently, a desired gas flow rate cannot be achieved.

### SUMMARY OF THE INVENTION

The present invention prevents compressive deformation of a gas flow path in the fuel cell that may occur when pressure is applied from both sides of the separators.

A first aspect of the present invention relates to a fuel cell formed by interposing a membrane electrode assembly having an electrolyte membrane and gas diffusion electrodes attached to both sides of the electrolyte membrane between separators. The fuel cell includes: a gas flow path forming member disposed between the separator and the gas diffusion electrode to form gas flow path for supplying reactant gas for power generation in the fuel cell to the gas diffusion electrodes; and an elastic member disposed between the separator and the gas flow path forming member and having an elastic modulus which is lower than that of the gas flow path forming member.

The present invention is applicable to a fuel cell of the type in which gas flow path forming member is interposed between a separator and an gas diffusion electrode to form gas flow path described before and pressure is applied from both sides of the separators as described before.

The fuel cell of the first aspect has the elastic member having an elastic modulus lower than that of the gas flow path forming member between the separator and the gas flow path forming member. Thus, when pressure is applied from both sides of the separators, the gas flow path forming member having an elastic modulus higher than that of the elastic member does not undergo compressive deformation and the elastic member having an elastic modulus lower than that of the gas flow path forming member undergoes compressive deformation. Therefore, compressive deformation of gas flow paths in the fuel cell is prevented when pressure is applied from both sides of the separators.

The present invention may be applied to either the anode (hydrogen electrode) side or the cathode (oxygen electrode) side in the fuel cell, or may be applied to both of the anode side and the cathode side.

For the gas flow path forming member, a material having high rigidity such as a metal porous material is preferably used. Then, compressive deformation of gas flow paths may be prevented more effectively when pressure is applied from both sides of the separators.

In the above fuel cell, the elastic member may have a hydrophilicity which is higher than that of the gas flow path forming member.

At the gas diffusion electrode of the membrane electrode assembly, water is generated by an electrochemical reaction between hydrogen and oxygen during power generation. The generated water is usually discharged out of the fuel cell through the gas flow path.

Since generated water having moved from the gas diffusion electrode to the gas flow path forming member may flow along a surface of the elastic member having a hydrophilicity higher than that of the gas flow path forming member, the efficiency with which generated water is discharged out of the fuel cell is improved. Therefore, flooding (a phenomenon in which the supply of reactant gas to the gas diffusion electrode is inhibited to the extent that the power generation performance is deteriorated by an excess amount of generated water) may be prevented.

The fuel cell may further include a hydrophilic member disposed between the elastic member and the gas flow path forming member and having a hydrophilicity which is higher than that of the gas flow path forming member.

Then, because the generated water having moved from the gas diffusion electrode to the gas flow path forming member is allowed to flow along surface of the hydrophilic member, the efficiency with which generated water is discharged out of the fuel cell is improved. Therefore, flooding may be prevented.

In the above fuel cell, when the elastic member has gas permeability, the hydrophilic member may be made of a gas impermeable material.

Then, the reactant gas flowing through the gas flow path forming member is prevented from permeating into the elastic member. Therefore, the reactant gas can be supplied to the gas diffusion electrode efficiently and efficiency of use of the reactant gas can be improved.

In any of the fuel cells having hydrophilic member between the elastic member and the gas flow path forming member, the elastic member may have a flat plate-like shape, and the hydrophilic member may be respectively formed integrally with the elastic member.

Then, because fewer parts are used in constructing the fuel cell unit, the fuel cell may be easily assembled and the process of production of the fuel cell can be simplified. In addition, the separator and the elastic member may be respectively formed integrally with each other. The gas flow path forming member and the hydrophilic member may be respectively formed integrally with each other.

In any of the fuel cells having a hydrophilic member between the elastic member and the gas flow path forming member, the elastic member may include a hygroscopic member, and the hydrophilic member may have a through-hole through which water generated during power generation in the fuel cell can pass.

In the fuel cell having a hydrophilic member between the elastic member and the gas flow path forming member, the efficiency with which water is discharged is improved as described before. Therefore, in a polymer electrolyte membrane fuel cell, dry-up (a phenomenon in which the electrolyte membrane becomes excessively dry to deteriorate the power generation performance) may occur.

In the present invention, water generated during power generation is allowed to flow along the surface of the hydrophilic member to discharge it and water that passed through the through-hole formed through the hydrophilic member is allowed to be held or released by the hygroscopic elastic member. Therefore, the electrolyte membrane is prevented from excessively drying. The size and number of the through-holes of the hydrophilic member may be set as appropriate for the specification of the fuel cell.

In the above fuel cell, the hygroscopic member may have a higher hygroscopicity than that of a base material of which the elastic member is mainly composed.

Then, the elastic member can hold a larger amount of generated water having passed through the through-hole of the hydrophilic member.

The elastic member may be made of a material through which water generated during power generation in the fuel cell passes, the gas diffusion electrode may have a hydrophilicity which is lower than that of the gas flow path forming members, the gas flow path forming member may have a hydrophilicity which is lower than that of the elastic members, and the elastic member may have a hydrophilicity which is lower than that of surface of the separator.

That is, the gas flow path forming member adjoining the gas diffusion electrode has a hydrophilicity higher than that of the gas diffusion electrodes, the elastic member adjoining the gas flow path forming member has a hydrophilicity higher than that of the gas flow path forming members, and the surface of the separator in contact with the elastic member has a hydrophilicity higher than that of the elastic member.

Water tends to flow toward a part with a higher hydrophilicity. Therefore, in the above configuration, the generated water is efficiently moved from the gas diffusion electrode to the gas flow path forming members, then from the gas flow path forming member to the elastic member, and then from the elastic member to the surface of the separator. That is, the generated water can be allowed to move quickly in a direction perpendicular to surface of the gas diffusion electrode. As a result, flooding is prevented.

The present invention does not necessarily include all the various features described above. Some of the features may be omitted or combined as needed.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is an explanatory view schematically illustrating a cross-sectional structure of a unit cell 100 as a first embodiment constituting a fuel cell.

FIG. 2 is an explanatory view schematically illustrating a cross-sectional structure of a unit cell 100A as a second embodiment constituting a fuel cell.

FIGS. 3A to 3C are explanatory views schematically illustrating a structure of a unit cell 100B as a third embodiment constituting a fuel cell.

FIG. 4 is an explanatory view schematically illustrating a cross-sectional structure of a unit cell 100C as a fourth embodiment constituting a fuel cell.

### DETAILED DESCRIPTION OF EMBODIMENTS

Description will be hereinafter made of the embodiments of the present invention based on examples in the following order: A. First embodiment: B. Second embodiment: C. Third embodiment: D. Fourth embodiment: E. Modifications:

### A. First Embodiment

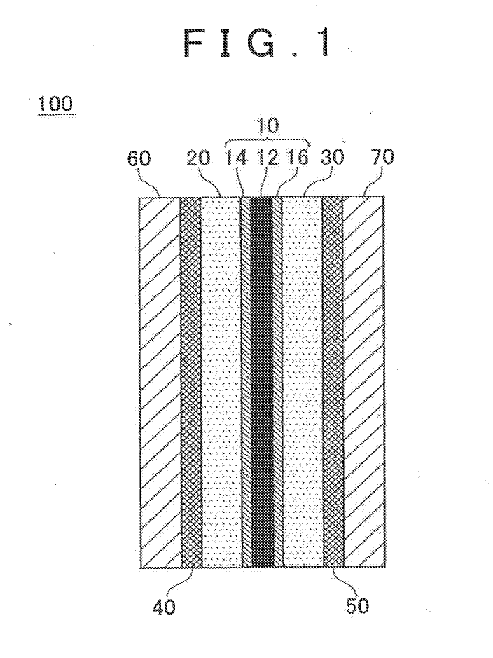

FIG. 1 is an explanatory view schematically illustrating a cross-sectional structure of a unit cell 100 as a first embodiment constituting a fuel cell. As illustrated, the unit cell 100 is formed by stacking an anode side gas flow path forming member 20 and an anode side elastic member 40 in this order on an anode side surface of a membrane electrode assembly 10, stacking a cathode side gas flow path forming member 30 and a cathode side elastic member 50 in this order on a cathode side surface of the membrane electrode assembly 10, and interposing them between a separator 60 and a separator 70. Although not shown, in the unit cell 100, pressure is applied in the stacking direction from both sides of the separators 60 and 70 to prevent deterioration of cell performance due to an increase in contact resistance in any part of the unit cell 100 and to prevent gas leakage.

The membrane electrode assembly 10 has an electrolyte membrane 12 with proton conductivity, and an anode side gas diffusion electrode (hydrogen electrode) 14 and a cathode side gas diffusion electrode (oxygen electrode) 16 attached to both sides of the electrolyte membrane 12. In this embodiment, a polymer electrolyte membrane is used as the electrolyte membrane 12. Another electrolyte membrane may be used as the electrolyte membrane 12.

In this embodiment, each of the anode side gas flow path forming member 20 and the cathode side gas flow path forming member 30 is made of a metal porous material, and forms a gas flow path. Hydrogen as a fuel gas flows through the anode side gas flow path forming member 20, and air containing oxygen as an oxidant gas flows through the cathode side gas flow path forming member 30. For the anode side gas flow path forming member 20 and the cathode side gas flow path forming member 30, other materials having electrical conductivity and gas diffusibility may be used instead of a metal porous material.

The anode side gas flow path forming member 20 and the cathode side gas flow path forming member 30 have rigidity high enough not to undergo compressive deformation under the pressure applied from both sides of the separators 60 and 70. In this embodiment, the anode side gas flow path forming member 20 and the cathode side gas flow path forming member 30 have been subjected to a hydrophilic treatment. A water contact angle in the anode side gas flow path forming member 20 and the cathode side gas flow path forming member 30 is set to an angle between 60° and 90°, for example.

In this embodiment, a carbon cloth is used for the anode side elastic member 40 and the cathode side elastic member 50. The carbon cloth has an elastic modulus lower than that of the metal porous material (i.e., the anode side gas flow path forming member 20 and the cathode side gas flow path forming member 30). For the anode side elastic member 40 and the cathode side elastic member 50, other materials having electrical conductivity and an elastic modulus lower than that of the anode side gas flow path forming member 20 and the cathode side gas flow path forming member 30 may be used instead of a carbon cloth. For example, a felt having electrical conductivity or a metal spring may be used for the anode side elastic member 40 and the cathode side elastic member 50. In this embodiment, the anode side elastic member 40 and the cathode side elastic member 50 have been subjected to a hydrophilic treatment. A water contact angle in the anode side elastic member 40 and the cathode side elastic member 50 is set to an angle between 30° and 60°, for example.

For the separators 60 and 70, various types of materials having electrical conductivity such as carbon and metals may be used. In this embodiment, the surfaces of the separator 60 and the separator 70 on the side of the membrane electrode assembly 10 have been subjected to a hydrophilic treatment. A water contact angle on the surfaces of the separator 60 and the separator 70 is set to an angle between 0° and 30°, for example.

In the unit cell 100 of this embodiment, the cathode side gas flow path forming member 30, the cathode side elastic member 50, and a surface of the separator 70 are subjected to a hydrophilic treatment as described before. As a result of the hydrophilic treatments, the cathode side gas flow path forming member 30 has a higher hydrophilicity than the cathode side gas diffusion electrode 16 adjoining thereto. The cathode side elastic member 50 has a higher hydrophilicity than the cathode side gas flow path forming member 30 adjoining thereto. The surface of the separator 70 has a higher hydrophilicity than the cathode side elastic member 50 in contact therewith. Because the cathode side gas flow path forming member 30, the cathode side elastic member 50, and a surface of the separator 70 have been subjected to a hydrophilic treatment as described above, and water tends to flow toward a part with a higher hydrophilicity, water generated at the cathode side gas diffusion electrode 16 by a cathode reaction during power generation moves quickly from the cathode side gas diffusion electrode 16 to the cathode side gas flow path forming member 30, then from the cathode side gas flow path forming member 30 to the cathode side elastic member 50, and then from the cathode side elastic member 50 to the surface of the separator 70. As a result, flooding on the cathode side in the unit cell 100 can be prevented.

Also, the anode side gas flow path forming member 20, the anode side elastic member 40, and a surface of the separator 60 have been subjected to a hydrophilic treatment: As a result of the hydrophilic treatments, the anode side gas flow path forming member 20 has a higher hydrophilicity than the anode side gas diffusion electrode 14 adjoining the anode side gas flow path forming member 20. The anode side elastic member 40 has a higher hydrophilicity than the anode side gas flow path forming member 20 adjoining the anode side elastic member 40. The surface of the separator 60 has a higher hydrophilicity than the anode side elastic member 40 contacting the surface of the separator 60. Therefore, water generated at the cathode side gas diffusion electrode 16 by a cathode reaction during power generation and passed through the electrolyte membrane 12 to the anode side gas diffusion electrode 14 quickly moves from the anode side gas diffusion electrode 14 to the anode side gas flow path forming member 20, then from the anode side gas flow path forming member 20 to the anode side elastic member 40, and then from the anode side elastic member 40 to the surface of separator 60. As a result, flooding on the anode side in the unit cell 100 is prevented.

In the unit cell 100 of the first embodiment described above, the anode side gas flow path forming member 20 and the cathode side gas flow path forming member 30 have rigidity high enough not to undergo compressive deformation under the pressure applied from the both sides of the separators 60 and 70 as describe before, and have an elastic modulus that is higher than that of the anode side elastic member 40 and the cathode side elastic member 50. Also, the unit cell 100 has the anode side elastic member 40 having an elastic modulus that is lower than that of the anode side gas flow path forming member 20 and the cathode side elastic member 50 having an elastic modulus that is lower than that of the cathode side gas flow path forming member 30. The anode side elastic member 40 is arranged between the separator 60 and the anode side gas flow path forming member 20. The cathode side elastic member 50 is arranged between the separator 70 and the cathode side gas flow path forming member 30. Therefore, when pressure is applied from both sided of the separators 60 and 70, the anode side gas flow path forming member 20 and the cathode side gas flow path forming member 30 do not undergo compressive deformation, and the anode side elastic member 40 and the cathode side elastic member 50 undergo compressive deformation. That is, according to a fuel cell to which the unit cell 100 of the first embodiment is applied, compressive deformation of gas flow paths can be prevented when pressure is applied from both sides of the separators 60 and 70.

### B. Second Embodiment

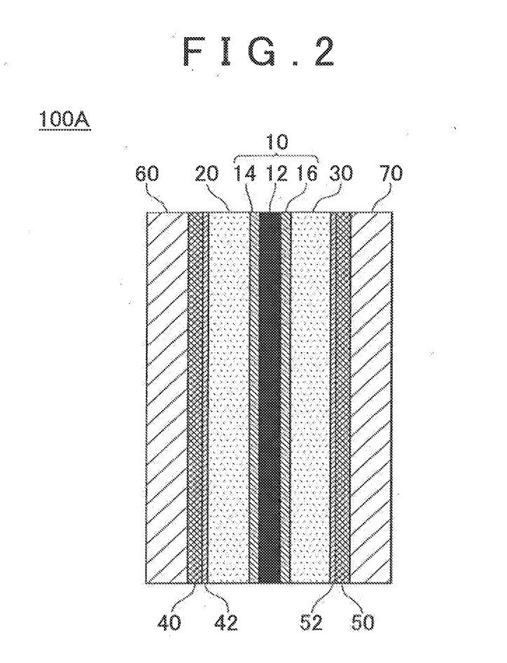

FIG. 2 is an explanatory view schematically illustrating a cross-sectional structure of a unit cell 100A as a second embodiment constituting a fuel cell. As illustrated, the basic configuration of the unit cell 100A is generally the same as that of the unit cell 100 of the first embodiment.

The unit cell 100A, however, has an anode side hydrophilic member 42 having a hydrophilicity which is higher than that of the anode side gas flow path forming member 20 between the anode side gas flow path forming member 20 and the anode side elastic member 40, and a cathode side hydrophilic member 52 having a hydrophilicity which is higher than that of the cathode side gas flow path forming member 30 between the cathode side gas flow path forming member 30 and the cathode side elastic member 50.

Thus, generated water having moved to the anode side gas flow path forming member 20 and the cathode side gas flow path forming member 30 from the anode side gas diffusion electrode 14 and the cathode side gas diffusion electrode 16 can be allowed to flow along surfaces of the anode side hydrophilic member 42 and the cathode side hydrophilic member 52. Therefore, the efficiency with which the generated water is discharged out of the unit cell 100A can be improved. As a result, flooding in the unit cell 100A can be prevented.

In this embodiment, the anode side hydrophilic member 42 and the cathode side hydrophilic member 52 are made of a gas impermeable material.

Thus, because hydrogen flowing through the anode side gas flow path forming member 20 is prevented from permeating the anode side elastic member 40, hydrogen may be supplied to the anode side gas diffusion electrode 14 efficiently and the efficiency of use of hydrogen is improved. Also, because air flowing through the cathode side gas flow path forming member 30 is prevented from permeating the cathode side elastic member 50, oxygen contained in the air can be supplied to the cathode side gas diffusion electrode 16 efficiently and the efficiency of use of oxygen is improved.

In this embodiment, the anode side elastic member 40 and the anode side hydrophilic member 42, and the cathode side elastic member 50 and the cathode side hydrophilic member 52 are formed integrally with each other. This is possible by bonding gold leaf to corresponding surfaces of the anode side elastic member 40 and the cathode side elastic member 50 or forming Ti—Au plating on corresponding surfaces of the anode side elastic member 40 and the cathode side elastic member 50, for example.

Then, the number of parts constituting the unit cell 100A can be reduced, and the process of production of the unit cell 100A can be simplified. In addition, the separator 60 and the anode side elastic member 40, and the separator 70 and the cathode side elastic member 50 may be formed integrally with each other.

In a fuel cell to which the unit cell 100A of the second embodiment described above is applied, since the unit cell 100A has the anode side elastic member 40 and the cathode side elastic member 50 as in the first embodiment, compressive deformation of gas flow paths can be prevented when pressure is applied from both sides of the separators 60 and 70.

### C. Third Embodiment

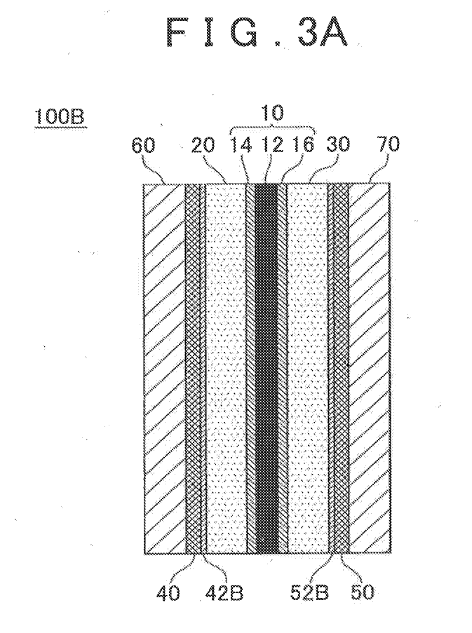

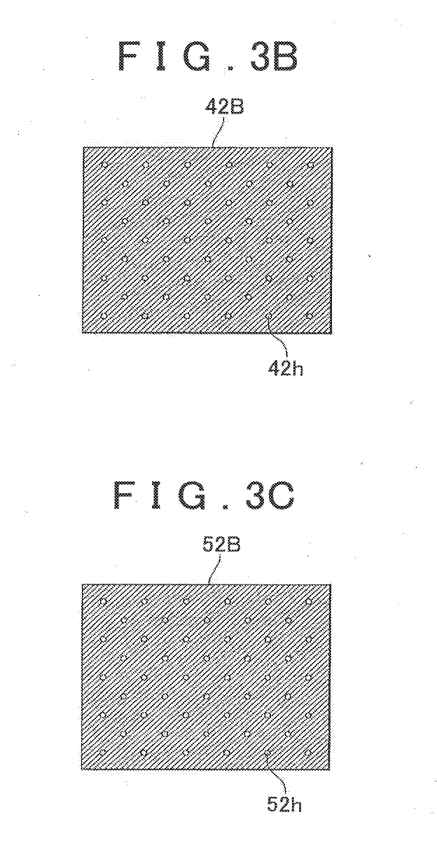

FIGS. 3A to 3C are explanatory views schematically illustrating a structure of a unit cell 100B as a third embodiment constituting a fuel cell. FIG. 3A shows a cross-sectional structure of the unit cell 100B, and FIGS. 3B and 3C show plan views of an anode side hydrophilic member 42B and a cathode side hydrophilic member 52B, respectively, which are described later. As shown in FIG. 3A, the basic configuration of the unit cell 100B is generally the same as that of the unit cell 100A of the second embodiment.

The unit cell 100B, however, has an anode side hydrophilic member 42B and a cathode side hydrophilic member 52B in place of the anode side hydrophilic member 42 and the cathode side hydrophilic member 52 in the unit cell 100A of the second embodiment. The anode side hydrophilic member 42 and the cathode side hydrophilic member 52 are formed integrally with the anode side elastic member 40 and the cathode side elastic member 50, respectively, as in the second embodiment.

As shown in FIG. 3B, the anode side hydrophilic member 42B has a plurality of through-holes 42h. Also, as shown in FIG. 3C, the cathode side hydrophilic member 52B has a plurality of through-holes 52h. This is attributed to the following reason.

The unit cell 100A of the second embodiment has the anode side hydrophilic member 42 and the cathode side hydrophilic member 52 to improve the generated water discharge efficiency. Therefore, in the unit cell 100A of the second embodiment, the electrolyte membrane 12 may be excessively dried and become dried-up. In this embodiment, therefore, a plurality of through-holes 42h and through-holes 52h are formed through the anode side hydrophilic member 42B and the cathode side hydrophilic member 52B, respectively, to allow water to flow along surfaces of the anode side hydrophilic member 42B and the cathode side hydrophilic member 52B to discharge the water and to allow the water that passed through the through-holes 42h and the through-holes 52h of the anode side hydrophilic member 42B and the cathode side hydrophilic member 52B to be held or released by the anode side elastic member 40 and the cathode side elastic member 50 of a hygroscopic carbon cloth. Therefore, according to the unit cell 100B of this embodiment, the electrolyte membrane 12 can be prevented from being excessively dried and be prevented from drying-up. The size and number of the through-holes 42h and the through-holes 52h of the anode side hydrophilic member 42B and the cathode side hydrophilic member 52B can be arbitrarily determined based on the specification of the unit cell 100B.

In a fuel cell to which the unit cell 100B of the third embodiment is applied described above, because the unit cell 100B has the anode side elastic member 40 and the cathode side elastic member 50 as in the first embodiment and the second embodiment, compressive deformation of gas flow paths may be prevented when pressure is applied from both sides of the separators 60 and 70.

### D. Fourth Embodiment

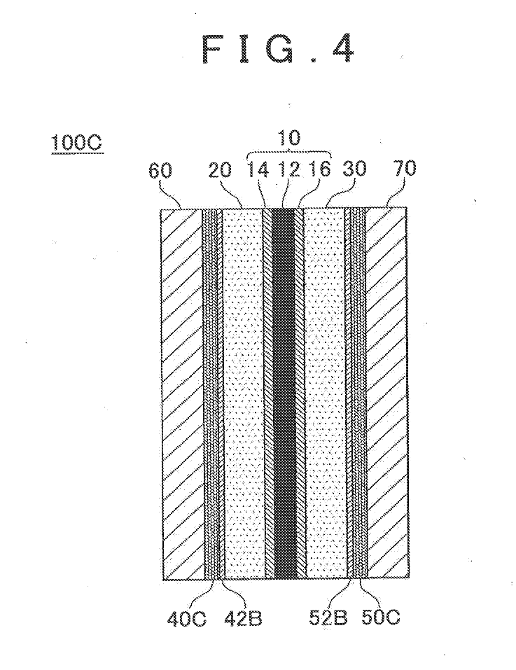

FIG. 4 is an explanatory view schematically illustrating a cross-sectional structure of a unit cell 100C as a fourth embodiment constituting a fuel cell. As illustrated, the basic configuration of the unit cell 100C is generally the same as that of the unit cell 100B of the third embodiment.

The unit cell 100C, however, has an anode side elastic member 40C and a cathode side elastic member 50C in place of the anode side elastic member 40 and the cathode side elastic member 50 in the unit cell 100B of the third embodiment. The anode side elastic member 40C and the cathode side elastic member 50C are composed mainly of a carbon cloth as the anode side elastic member 40 and the cathode side elastic member 50 described before, and the anode side elastic member 40C and the cathode side elastic member SOC each has therein a high hygroscopic member having a hygroscopicity which is higher than that of the carbon cloth. For the high hygroscopic member, a water absorbing polymer, a hydrophilic fabric or a hygroscopic fabric, for example, can be used.

Therefore, the anode side elastic member 40C and the cathode side elastic member 50C can hold a larger amount of generated water having passed through the through-holes 42h and the through-holes 52h of the anode side hydrophilic member 42B and the cathode side hydrophilic member 52B than the anode side elastic member 40 and the cathode side elastic member 50 in the third embodiment.

In a fuel cell to which the unit cell 100C of the fourth embodiment is applied described above, since the unit cell 100C has the anode side elastic member 40C and the cathode side elastic member 50C as in the first to third embodiments, compressive deformation of gas flow paths can be prevented when pressure is applied from both sides of the separators 60 and 70.

### E. Modifications

While some embodiments of the present invention have been described, the present invention is not limited to the embodiments and can be implemented in various forms without departing from the scope thereof. For example, the following modifications can be made.

E1. Modification 1: The unit cells 100, 100A, 100B, 100C in the above embodiments, which have both of the anode side elastic member and the cathode side elastic member, may only have either an anode side elastic member or a cathode side elastic member.

E2. Modification 2: While the anode side gas flow path forming member 20, the cathode side gas flow path forming member 30, the anode side elastic member 40, the cathode side elastic member 50, a surface of the separator 60, and a surface of the separator 70 have been subjected to a hydrophilic treatment in the first embodiment as described before, the present invention is not limited thereto and these members may not have been subjected to a hydrophilic treatment.

E3. Modification 3: The unit cell 100A, which has both of the anode side hydrophilic member 42 and the cathode side hydrophilic member 52 in the second embodiment, may only have either the anode side hydrophilic member 42 or the cathode side hydrophilic member 52.

E4. Modification 4: While the anode side elastic member 40 and the anode side hydrophilic member 42, and the cathode side elastic member 50 and the cathode side hydrophilic member 52 are formed integrally with each other in the second embodiment, the anode side gas flow path forming member 20 and the anode side hydrophilic member 42, and the cathode side gas flow path forming member 30 and the cathode side hydrophilic member 52 may be formed integrally with each other instead. Also, the anode side elastic member 40 and the anode side hydrophilic member 42, and the cathode side elastic member 50 and the cathode side hydrophilic member 52 are formed separately from each other.

Also, instead of providing the anode side hydrophilic member 42 between the anode side gas flow path forming member 20 and the anode side elastic member 40, the anode side elastic member 40 may be made of a material having a hydrophilicity which is higher than that of the anode side gas flow path forming member 20. Also, instead of providing the cathode side hydrophilic member 52 between the cathode side gas flow path forming member 30 and the cathode side elastic member 50, the cathode side elastic member 50 may be made of a material having a hydrophilicity which is higher than that of the cathode side gas flow path forming member 30.

E5. Modification 5: The unit cell 100B, which has both the anode side hydrophilic member 42B and the cathode side hydrophilic member 52B in the third embodiment, may only have either the anode side hydrophilic member 42B or the cathode side hydrophilic member 52B.

Also, while the anode side hydrophilic member 42B and the cathode side hydrophilic member 52B having the through-holes 42h and the through-holes 52h, respectively, are used as the anode side hydrophilic member and the cathode side hydrophilic member, respectively, in the third embodiment, metal mesh made of a material having hydrophilicity may be used instead.

E6. Modification 6: The unit cell 100C, which has both of the anode side elastic member 40C and the cathode side elastic member 50C in the fourth embodiment, may only have either the anode side elastic member 40C or the cathode side elastic member 50C.

E7. Modification 7: A case where the present invention is applied to a unit cell is described as an example in the above embodiments, the present invention may be applied to a fuel cell having a stack structure in which a plurality of unit cells are stacked on top of another.

1. A fuel cell comprising:
a membrane electrode assembly provided with an electrolyte membrane and gas diffusion electrodes attached to both sides of the electrolyte membrane;
separators that support the membrane electrode assembly from both sides thereof;
a gas flow path forming member disposed between the separator and the gas diffusion electrode to form gas flow path for supplying reactant gas for power generation in the fuel cell to the gas diffusion electrode, wherein the reactant gas flows within the gas flow path forming member; and
an elastic member, disposed between the separator and the gas flow path forming member, that has an elastic modulus lower than that of the gas flow path forming member,
wherein the elastic member is in direct contact with the separator.

2. The fuel cell according to claim 1, wherein the elastic member has a hydrophilicity higher than that of the gas flow path forming member.

3. The fuel cell according to claim 1, further comprising: a hydrophilic member disposed between the elastic member and the gas flow path forming member and having a hydrophilicity higher than that of the gas flow path forming member.

4. The fuel cell according to claim 3, wherein the hydrophilic member is made of a gas impermeable material.

5. The fuel cell according to claim 3, wherein the elastic member has a flat plate-like shape, and the hydrophilic member is formed integrally with the elastic member.

6. The fuel cell according to claim 3, wherein the elastic member includes a hygroscopic member, and the hydrophilic member have a through-hole through which water generated during power generation in the fuel cell passes.

7. The fuel cell according to claim 6, wherein the hygroscopic member has a hygroscopicity higher than that of a base material of which the elastic member is mainly composed.

8. The fuel cell according to claim 1, wherein the elastic member is made of a material through which generated water generated during power generation in the fuel cell can pass, the gas diffusion electrode has a hydrophilicity which is lower than that of the gas flow path forming member, the gas flow path forming member has a hydrophilicity which is lower than that of the elastic member, and the elastic member has a hydrophilicity which is lower than that of surface of the separator.

9. The fuel cell according to claim 1, wherein the gas flow path forming member is a metal porous material.

10. The fuel cell according to claim 1, wherein the reactant gas flows within the elastic member.

11. A fuel cell comprising:
a membrane electrode assembly provided with an electrolyte membrane and gas diffusion electrodes attached to both sides of the electrolyte membrane;
separators that support the membrane electrode assembly from both sides thereof;
a gas flow path forming member disposed between the separator and the gas diffusion electrode to form gas flow path for supplying reactant gas for power generation in the fuel cell to the gas diffusion electrode, wherein the reactant gas flows within the gas flow path forming member; and
an elastic member, disposed between the separator and the gas flow path forming member, that has an elastic modulus lower than that of the gas flow path forming member,
wherein the elastic member is a carbon cloth.

12. The fuel cell according to claim 1, wherein the elastic member is a felt having electrical conductivity or a metal spring.
